(19) United States
(12) Patent Application Publication
(10) Pub. No.: US 2002/0048099 A1
(43) Pub. Date: Apr. 25, 2002

(54) "FRONT SURFACE MIRROR WITH PROTECTIVE COATING"

(76) Inventor: HEINRICH LANG, ERGERSHEIM (DE)

Correspondence Address: JEFFREY M KARMILOVICH, DORITY & MANNING, P O BOX 1449, GREENVILLE, SC, 296021449

(21) Appl. No.: 09/267,798

(22) Filed: Mar. 12, 1999

(30) Foreign Application Priority Data
Jun. 9, 1998 (DE) 198 25 819.4

(51) Int. Cl. G02B 5/08

(52) U.S. Cl. 359/870

(57) ABSTRACT

A mirror pane for a front-surface mirror includes: a carrier plate including a front side defining a first main surface, a reflective coating disposed upon the first main surface, and a transparent, scratch-resistant nano-composite protective coating disposed upon and covering the reflective coating. The protective coating may include an inorganic-organic nano-composite gradient coating with fluoridized organic side chains.

### DESCRIPTION

The invention is concerned with a mirror pane for a front surface mirror, in particular for rearview mirrors on motor vehicles and with a rearview mirror with a mirror pane of such a type.

Front surface mirrors with chromium as a reflection coating have been frequently installed on motor vehicles as “glare free” rear vision mirrors. This glare freedom, however, carries the trade-off of low resistance to scratch damage when chromium is used as a reflection coating. For this reason, this type of front surface mirror scarcely came into use for outside application and for commercial vehicle installation.

The treatment of cockpit windshields with a water repellant coating has been made known from aviation technology. These water repellant coatings prevented the buildup of fog, and because of the high air speed of airplanes the line of sight for the pilots remains clear. Also, in the field of sanitation, coatings for Plexiglas walls of shower stalls and the like are offered, which coatings are dirt repellent and ease the cleaning operation.

Thus, the purpose of the invention is to make available a mirror pane for a front surface mirror, in particular for rearview mirrors of motor vehicles, which can be installed externally on commercial vehicles. Further, it is the purpose of the present invention, to make available a rearview mirror possessing a mirror pane of the above type.

The achievement of these purposes is accomplished by the features of claims 1 and 10 of the present patent.

Experience has shown, that mirror panes of front surface mirrors, which are coated with a water repellent coating as known in the sanitary field, possess a substantially greater scratch resistance coating, than can be said for front surface mirrors which lack such coatings.

Additionally, this coating naturally has the effect, that the mirror pane resists dirt and is easier to clean. The mirror panes in accord with the invention and rearview mirrors with such panes, permit freeing from ice and snow without scratch damage to the mirror.

Set forth as especially well adapted for such protective coatings, the firm INM (Institute for New Materials, gem. GmbH) has developed and marketed an inorganic, nano-composite, gradiated layer coating with fluoridized organic side chains, which are presented as “Easy-to-clean-coatings”. Coatings using this material are optically transparent, exhibit a high UV stability as well as a high scratch and abrasion resistance. This material is amenable to application by conventional means, such as dip, spray, or spin coatings, with subsequent photochemical and/or thermal hardening.

In accord with a particularly advantageous embodiment of the invention, the protective coating is also applied over the side edges of the mirror pane, whereby the interstitial space between the carrier plate and the reflective coating is sealed and protected. This interstitial space between the reflective coating and the carrier plate is particularly susceptible to corrosion. In the case of the mirror in accord with the present invention, simultaneously, a protective coating is applied on the front side and a sealing of the said interstitial space on the sides is achieved with the application of a single protective coating. The placing of an additional protective coating on the sides is thus made superfluous.

Under acceptable carrier plates, glass as well as plastic plates may be considered. Besides chromium as the reflective coating, because of the increased protection from scratching, the softer and more sensitive aluminum and also the sensitive interference coatings may be applied.

Further details, features and advantages of the invention, are found in the following description of advantageous embodiments, with reference to the drawing. There is shown in:

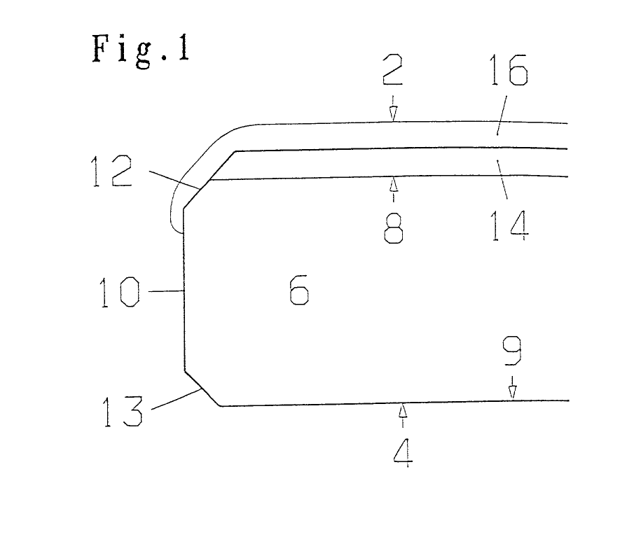

FIG. 1 a sectional view through the mirror pane of a front surface mirror with chromium as the reflective coating.

FIG. 1 shows a sectional view through a first embodiment of a mirror pane, in accord with the present invention. The mirror pane depicted in FIG. 1 shows a front side 2, from which side the mirror will be observed, and a back side 4. A glass plate 6 possesses a first and second main surface 8 and 9, as well as sides 10. The edges of the sides 10 are beveled, that is, the side 10 exhibits upper and lower beveled edges 12 and 13. On the first main surface 8 of the glass plate 6 a chromium coating 14 is applied as a reflective means, that is, the reflective coating 14 is placed on the front side of the mirror pane, so that a so-called front surface mirror is at hand. As the most outward coating on the front side 2, a protective coating 16 is applied which is comprised of a dirt and water repellent material. The protective coating 16 is, in this case, extended from the front side 2 over the area 12 of the side 10. Thereby, the said interstitial area is also protected by the protective coating 16 where the chromium coating 14 and the glass plate 8 form the upper beveled area 12. Because of the scratch free coating on the inherently sensitive chromium coating 14 of the front surface mirror, the installation of this mirror in motor vehicles, and in particular, commercial vehicles is possible.

1. A mirror pane for a front surface mirror, in particular for rearview mirrors on motor vehicles, with a front side (2) and a back side (4), a reflection coating (14) applied on the front side (2) of a carrier plate (6), characterized by a transparent, scratch resistant protecting coating (16) applied on the front side (2) as the outermost coating on the reflection coating (14).

2. A mirror pane in accord with claim 1, therein characterized, in that the protective coating (16) is dirt and water repellent.

3. A mirror pane in accord with claim 2, therein characterized, in that the protective coating (16) is an inorganic-organic nano-composite gradient coating with fluoridized organic side chains.

4. A mirror pane in accord with one of the foregoing claims, therein characterized, in that the protective coating (16), covers the side (10) and edge (12) and at least the interstitial zone between the reflection coating (14) and the carrier plate (6).

5. A mirror pane in accord with one of the foregoing claims, therein characterized, in that the reflection coating (14) is a chromium coating.

6. A mirror pane in accord with one of the foregoing claims 1 to 4, therein characterized, in that the reflection coating (14) is an aluminum coating.

7. A mirror pane in accord with one of the foregoing claims 1 to 4, therein characterized, in that the reflection coating (14) is an interference coating.
